(19) United States
(12) Patent Application Publication
(10) Pub. No.: US 2009/0090148 A1
(43) Pub. Date: Apr. 9, 2009

(54) LOCK SENSOR DETECTION SYSTEM

(76) Inventors: Adam Kollin, Troy, MI (US); Matthew Marko, Waterford, MI (US)

Correspondence Address: KOHN & ASSOCIATES, PLLC, 30500 NORTHWESTERN HWY, SUITE 410, FARMINGTON HILLS, MI, 48334, US

(21) Appl. No.: 11/867,017

(22) Filed: Oct. 4, 2007

(51) Int. Cl. E05B 41/00

(52) U.S. Cl. 70/263; 70/432

(57) ABSTRACT

A lock sensor detection system for detecting when a door latch assembly is in a locked condition and in engagement with a door jamb includes a circuit having an open and closed condition. The circuit is in the closed condition when the door latch assembly is in the locked condition and in engagement with the door jamb. An actuator, preferably a magnet, is adapted to be disposed in the door jamb for actuating a circuit, preferably a magnetic circuit, when the circuit is in the closed condition and the door latch assembly engages the door jamb. A signal emitting component is disposed within and operatively connected to the door latch assembly for providing a signal in response to the circuit being in the closed and actuated conditions indicating that the door latch assembly is in an engaged and locked condition.

### BACKGROUND OF THE INVENTION

1. Field of the Invention

Generally, the present invention relates to sensor systems for detecting a locked or unlocked condition. More specifically, the present invention relates to sensor systems for detecting the locked or unlocked condition for various types of doors for homes and buildings.

2. Description of Related Art

Locks are available in many different forms and configurations. For the most part, locks include a housing, which accommodates a reciprocating latch or lever, the latch being movable between an unlocked withdrawn position and a locked extended position. In the withdrawn position, the latch would normally be contained within the housing, while in the extended position; the latch engages an external and adjacent object to effect the locking operation. The latch is movable between the withdrawn and extended position in response to the rotation of a key in the lock, or rotation of a handle, although such movements can also be in response to electrical, magnetic, pneumatic, or other types of mechanical activation.

It is also known to those of skill in the art to provide external sensors with respect to such locks. Conventionally, a sensing switch or other device is located outside of the lock in order to sense or determine the position of the latch. The mechanical movement of the latch into the extended position has the effect of activating the sensor to provide a signal as to its condition, while the sensor would be activated in another manner to indicate the withdrawn or unlocked position of the lever. Many conventional locks for doors, however, do not utilize dead bolts for locking but instead provide locking by an internal lock of the door latch bolt or door knob. This renders it more difficult to sense the condition of the lock.

It may be desirable to determine the position of the latch, namely, whether in the extended or retracted position, so that devices or systems can be operatively connected to the lock and react according to the position of the latch. For example, the lock may be operatively connected to an alarm system, such that when the lock is moved from the locked to the unlocked position, or when the door is opened while the lock is in the locked position (i.e., the door is kicked in), while the alarm is operational, means are provided to trigger the alarm. The lock can also be operatively connected to video and/or audio recording equipment, heating and cooling systems, lighting systems, computers and/or other recording instruments to collect information on personnel or objects entering or leaving a particular area, especially areas that contain information or products that may be of a classified or confidential nature.

The above description mostly discusses dead-bolt type locks. It is straight-forward to detect remotely if a deadbolt type lock is in a locked condition. If the bolt is detected to be inside of the door jamb, then the door is by definition both closed and locked. No separate mechanism is needed to test for both conditions.

Many alarm systems require a ready signal from a door before the alarm can be set into the “away position.” Most existing alarms only consider the case of the door being closed. The present lock detection system is designed to detect that a door is both closed and the lock is in the locked position when a deadbolt is not available, or it is desirous to not use it. It is not enough to know that the bolt is in the door-jamb. The lock may be left unlocked so anyone can still readily enter the building or home.

In an effort to overcome the above-referenced problems, U.S. Pat. No. 6,441,735, to Marko et al, which is owned by Marlin Security Systems, Inc. disclosed a lock sensor detection system for an internal lock. The system was designed to provide a signal in response to the actuation of an internal lock mechanism to a locked condition. The system is positioned in both the door jamb and the door lock and senses the lock signal and in turn provides a signal to a security or surveillance system with regard to the status of the lock. One significant problem with the system is the difficulty of installing the system. Since the magnetic switch is located in the door frame, the wiring of the system is very labor intensive and is thus costly. It would therefore be beneficial to develop a system for detecting the condition of an internal lock without the costs and labor requirements of the known devices.

### SUMMARY OF THE INVENTION

According to the present invention, there is provided a lock sensor detection system for detecting when a door latch assembly is in a locked condition and in engagement with a door jamb. The system includes a circuit having an open and closed condition. The circuit is in the closed condition when the door latch assembly is in the locked condition and the door lock assembly engages the door jamb. The system further includes an actuator adapted to be disposed in the door jamb for actuating the circuit when the circuit is in the closed condition and the door latch assembly engages the doorjamb. A signal emitting component is adapted to be disposed within and operatively connected to the door latch assembly for providing a signal and response to the circuit being in the closed and actuated conditions, thereby indicating that the door latch assembly is in an engaged and locked condition.

The present invention further provides a method of sensing when a door latch assembly is in a locked condition and in engagement with a door jamb. The method includes the steps of closing a circuit when a door latch assembly is in a locked condition, engaging the door jamb, and actuating the circuit with an actuator disposed in a door jamb when the circuit is closed and the door latch assembly engages the door jamb. A signal is emitted from the door latch assembly in response to the circuit being closed and actuated indicating that the door latch assembly is in an engaged and locked condition.

The present invention further provides a door latch assembly and door assembly.

### DESCRIPTION OF THE DRAWINGS

Other advantages of the present invention are readily appreciated as the same becomes better understood by reference to the following detailed description, when considered in connection with the accompanying drawings wherein:

FIG. 1 is a top perspective view of a generally conventional door latch assembly modified to include the lock sensor alarm system of the present invention;

FIG. 2 is a an exploded view of the components of the lock sensor alarm system;

FIG. 3 is a front view of the non-key, ribbed pivot button lock actuated subassembly and the door being flush with the frame;

FIG. 4 is a side view of the door knob subassembly;

FIG. 5 is a top view of the door knob subassembly showing components of the lock sensor alarm system;

FIG. 6 is a sectional view of the door knob subassembly of FIG. 4 taken along the lines A-A in FIG. 4 and showing the lock in the actuated locked condition with a sensor actuating pivot plate in its locked sensing position;

FIG. 7 is a sectional view taken along the lines B-B in FIG. 6 and showing the lock in the deactuated condition;

FIG. 8 is a view of the magnetic flux of the lock sensor alarm system;

FIG. 9 is side view of the lock sensor alarm system in the closed position;

FIG. 10 is a side view of the lock sensor alarm system in the open position; and

FIG. 11 is a side view of the lock sensor alarm system showing the magnetic flux with two screws; and

FIG. 12 is a side view of the lock sensor alarm system showing a limit switch.

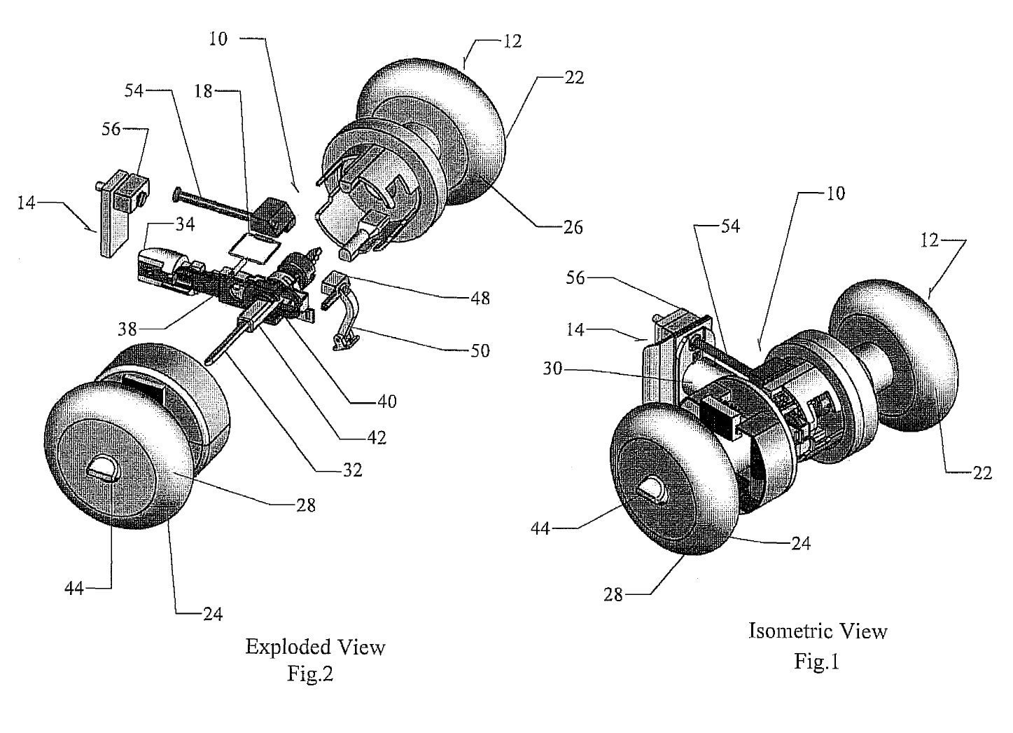

### DETAILED DESCRIPTION OF THE INVENTION

A locked sensor detection system for detecting when a door latch assembly is in a locked condition and engagement with a door jamb is generally shown at 10 in the figures. The system 10 includes components mounted in conjunction with the door latch assembly generally shown at 12 and in the door jamb 14. The lock sensor detection system 10 detects when the door latch assembly 12 is both in a locked condition and in engagement with the door jamb 14. A signal is actuated, thereby indicating that the door latch assembly provides security, as opposed to being in engagement but not locked or locked but not in engagement.

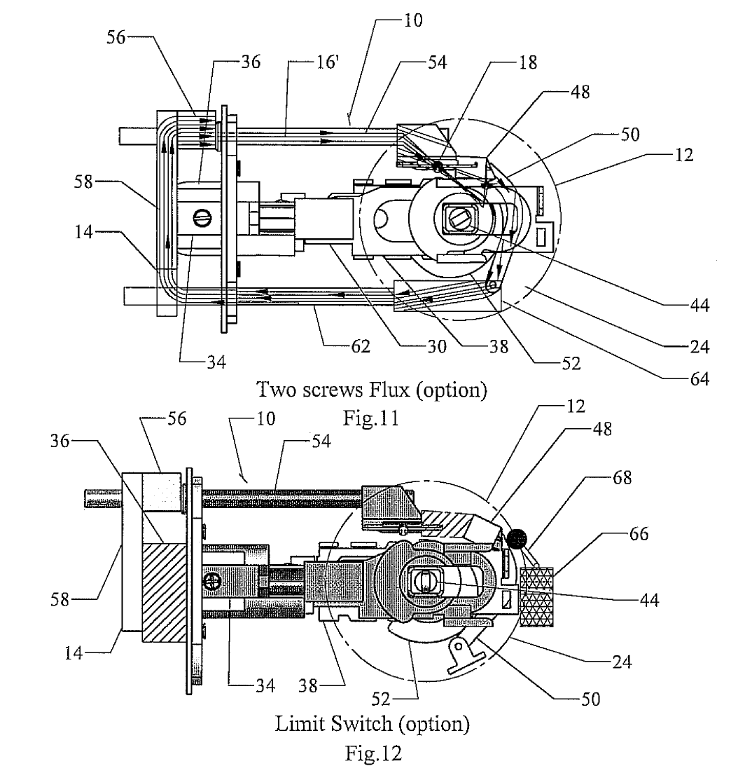

The lock sensor detection system 10 includes a circuit, generally shown at 16 in FIGS. 8 and 11, having an open and closed condition. The circuit 16 is in the closed condition when the door latch assembly 12 is in the locked condition and is engagement with the door jamb as explained below in detail. An actuator, preferably in the form of a magnet, when the circuit 16 is a magnetically actuated circuit as explained below, is adapted to be disposed in the door jamb 14 for actuating the circuit 16 when the circuit 16 is in the closed condition and the door latch assembly 12 engages the door jamb 14. A magnetic flux sensing and signal actuating component, such as a reed switch 18, as shown in FIGS. 2 6, 8 and 11, is operatively connected to a signal emitting system, such as an alarm system or the like, and disposed within and operatively connected to the door latch assembly 12 within the door per se for providing a signal in response to the circuit being in the closed and actuated conditions indicating that the door latch assembly is in an engaged and locked condition. Therefore, unlike the lock sensor detection system disclosed in the Marco, et al. U.S. Pat. No. 6,441,735, which makes wiring to the door frame mounted switch labor intensive, the present invention places the actuator, such as the magnet, within the door frame and the switch and signaling components inside the door. The present invention can also be integrated to a transmitter, such as a radio frequency (RF) transmitter, eliminating all wires and providing a clean installation appearance. This much more simple configuration is an improvement over the prior art that require wires to be run from the magnetic switch assembly in the door jamb through the door frame, often requiring removal of surrounding moldings and the like when the assembly was installed in an existing door and frame assembly. Such an installation is time consuming to install and provides a much cleaner appearance.

Referring specifically to the preferred embodiment 10 as shown in the figures, the present invention is for use in general with a basic door latch assembly with relatively minor changes. In this regard, the door latch assembly shown by way of example and not of limitation, has the basic construction of a form made by DS&A, Inc. and sold under part number 51073 and, except for the changes described herein, is of that basic construction. A similar unit is made and sold by Schlage.

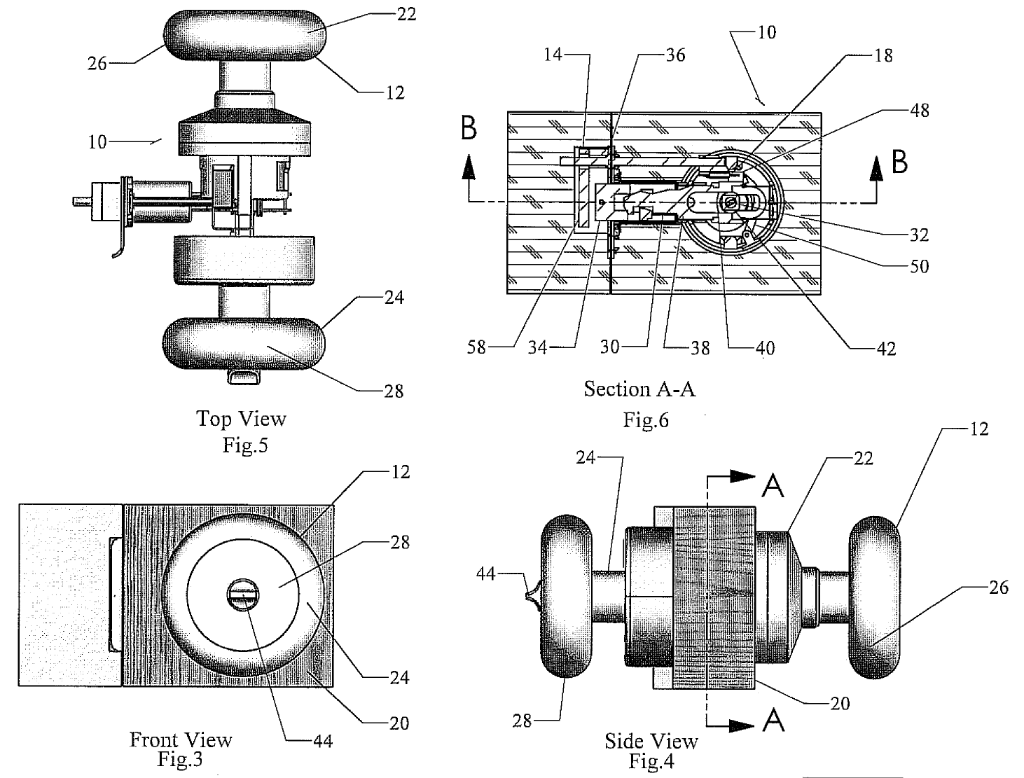

As shown in various of the figures, the door latch assembly 12 is mounted to a door 20, shown best in FIGS. 3 and 4. The door latch assembly 10 includes a first door knob subassembly 22 mounted on one side of the door 20 and a second door knob assembly 24 mounted on the opposite side of the door 20. The first door knob subassembly 22 includes a rotatable door knob 26 mounted to the door 20 by means well known in the art. Similarly, the second door knob subassembly 24 includes a rotatable door knob 28 also mounted to the door 20 by means well known in the art. Of course, various other handle constructions, such as levers or the like, can be used with the present invention. In this regard, the first and second door knob subassemblies 22, 24 are held to the door 20 in operative alignment with each other, usually by thread bolts or the like, not shown in the drawings, from one of the subassemblies 22, 24 and being threadedly engaged with two internally threaded studs in the other of the subassemblies 22, 24, not shown in the figures.

The door latch assembly includes a housing subassembly generally shown at 30 of the type well known in the art, but adapted in accordance with the present invention. Generally, a rotator shaft or spindle 42 is rotatably connected to the first door knob 26 and extends through the door 20 and into engagement with the second door knob 28. In this way, a rotation of either door knob 26, 28 can rotate the other by way of the spindle 42. The spindle 42 works in conjunction with the locking mechanism, which will prevent rotation of the spindle and connected door knobs 26, 28 when the door latch assembly 12 is placed in its locked condition.

Alternatively, the rotation of one door knob 26, 28 does not rotate the other, allowing for one knob 26, 28 to maintain the locked condition and the other being able to open the door, i.e., the door can be locked from the outside, but able to be unlocked from the inside.

The door latch assembly 12 includes an elongated latch 34 supported in the housing subassembly 30. Either of the door knob subassemblies 22, 24 are mounted for driving the latch 34 to a retracted position, as shown most clearly in FIGS. 9 and 11 from a retracted condition most clearly shown in FIGS. 10 and 12, although illustrated to various extents in various of the other figures. In the retracted position, the latch 34 is seated within a recess or pocket 36 of the door jamb 14, thereby defining an engaged condition of the door latch assembly 12 within the door jamb 14. In this condition, the door 20 cannot be moved relative to the door frame incorporating the doorjamb 14 without rotation of one or the other of the door knobs 26, 28 to draw the latch 34 into the retracted or disengaged condition. This typifies the operation of a common door knob assembly. Accordingly, the further function of the latch 34 relative to the door jamb 14 need not be explained in further detail herein.

The latch 34 is mounted on a pull member 38 by means well known in the art. The housing subassembly through a cam mechanism 40 shown in various of the figures and well known in the art translates rotational motion of the door knobs 26, 28 into linear motion of the pull 38.

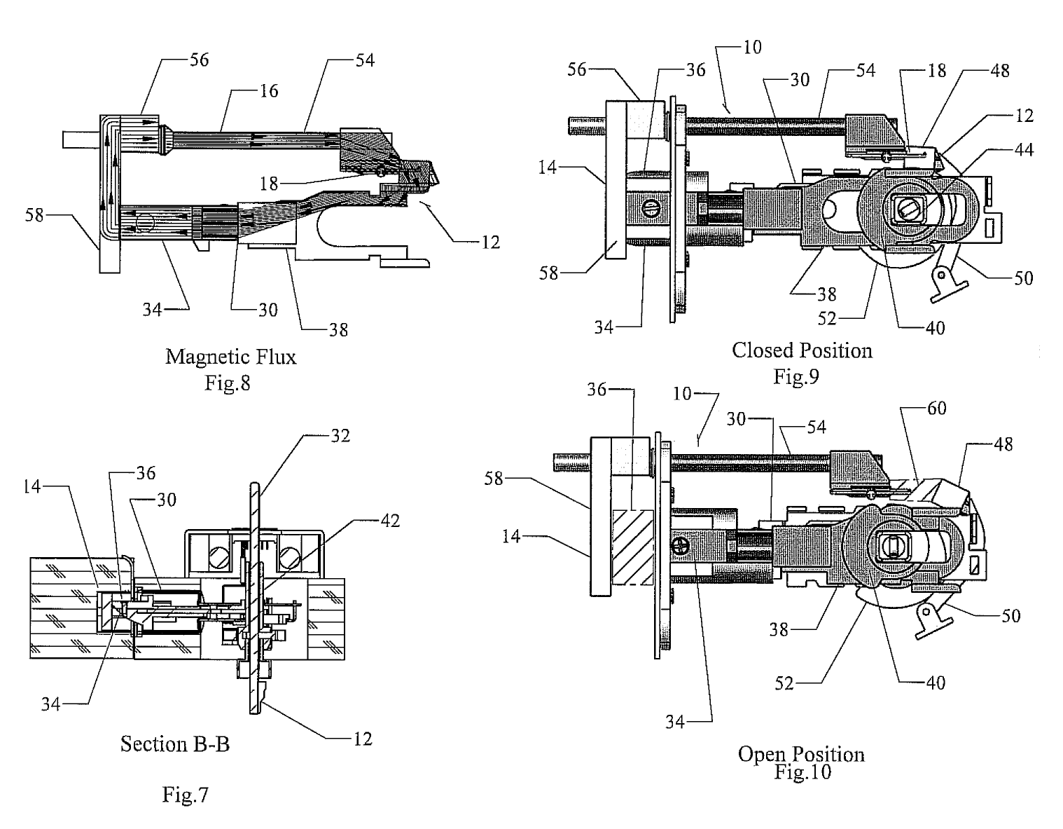

The figures herein show a typical locking mechanism adapted to be locked by a key applied through a keyhole in the door knob 26 (key and keyhole not shown). Generally, the key, upon insertion into the keyhole, will be in operative engagement with a lock shaft shown at 32 in FIGS. 2, 6 and 7. The lock shaft 32 is of a tubular construction and operates in a manner similar to locking mechanisms well known in the art. A rotatable pivot button 44 is operatively connected to the door knob 28. Generally, the key actuator is located outside of a room including the door assembly and the door knob 28 including the ribbed pivot button 44 is located on the inside of the door assembly. The co-operation of these locking mechanism actuators are well known in the art. Various alternatives for such locking mechanisms, such as key entry locks on both knobs of the door knob assembly or the like, are well known in the art and need not be described in further detail herein.

The above, in general terms, describes a typical door knob assembly, which is adapted for mounting of the present invention thereon. As generally described above, the present invention includes a circuit 16, two embodiments of which are shown in FIGS. 8 and 11. As shown in FIG. 8, the circuit 16, which is shown preferably as a magnetic flux circuit, includes the latch member 34 and pull 30 in operative communication with an end portion 48 of a rotatable arm 50. The arm 50 is movable, by actuation of the locking mechanism between a position where the end portion connector 48 bridges a gap between the pull 38 and reed switch 18. In the unlocked condition, cam 52 is operatively connected to the door lock mechanism and abuts the arm 50 so that the connector end 48 is moved out of engagement with the reed switch 18. The effect of this engagement and disengagement with the reed switch will be explained below.

The reed switch 18, as shown in FIG. 8, is in operative connection with screw member 54. When the door is closed relative to the door frame and the end of the screw 54 is brought in proximity adjacent to the magnet 56, the continuity of the circuit continues. The magnet 56 is mounted on a magnetically conductive plate 58, which is an integral part of the door jamb 14. The magnet 56 and magnetically conductive plate can be of one single construction or can be separate and operatively attached. When the latch 34 is in the engaged condition, as discussed above, with the door jamb 14, the latch 34 engages or is sufficiently in proximity to the plate 58 to complete the circuit 16. Various parts of the door latch assembly 12 can also be made to be magnetic in the circuit, such as the screw 54 and the latch 34, instead of or in addition to the magnet 56.

As described above, the circuit 16 can be opened or closed as a result of various functions of the lock sensor detection system 10 in conjunction with the door latch assembly 12. Actuation of the latch 34 into the extended condition within the doorjamb 14 in combination with actuation of the arm 50 by the lock assembly such that the connector end 48 engages the reed switch 18 places the circuit 16 in the closed condition. If for whatever reason, such as the door being opened or not fully closed, the latch 34 is not seated within the recess 36 of the doorjamb 14, the circuit is in the open condition. Likewise, if the door is not in the locked condition or, as shown in FIG. 10, the door latch 34 is not in the engaged extended condition, the pull 38 engages the arm 50 to pivot such that a gap 60 is created between the connector end portion 48 and the reed switch 18, thereby placing the circuit 16 in the open condition. In other words, for the circuit 16 to be in the closed condition, the latch 34 must be seated in the pocket 36 of the doorjamb 14 and the door latch assembly 12 must be in the locked condition.

The magnet 56 is an actuator, disposed within the doorjamb 14 for actuating the circuit 16 when the circuit is in the closed condition and the door latch assembly 12 engages the doorjamb 14. The magnetically actuated circuit 16 is not actuated if the door latch 34 is in the extended position and the door lock assembly 12 is in the locked condition unless the latch 34 is seated within the doorjamb 14 such that the magnet 56 actuates the circuit 16. The circuit 16 cannot be actuated unless the door is fixedly engaged within the door frame and locked therein. Hence, the combination of the actuator, in this embodiment in the form of a magnet 56, with the magnetic flux circuit 16 provides various fail safes to prevent actuation of the circuit 16 unless the door is engaged in the door frame by the present door latch assembly. The magnetic field can return by a path of air, completing the circuit 16.

The reed switch 18 is operatively connected by conductors (not shown) to the signal, alarm and/or other surveillance system to provide an indication, signal or alarm as to the locked or unlocked condition of the door 20. Such signal, alarm and/or surveillance systems are well known in the art and the details of such systems have been omitted for purposes of simplicity and brevity herein.

FIG. 11 shows an alternative embodiment of a circuit 16′ instructed in accordance with the present invention. In this embodiment, the latch 34 and pull 38 do not act as part of the circuit 16′. Rather, the assembly 10 includes a second screw 62 operatively connected between the plate 58 and arm 50 by an arm support 64, thereby completing the circuit 16′ when screws 54 and 62 are brought in proximity of the door jamb 14 and aligned therewith, as shown by the arrows in FIG. 11.

Although the circuits 16, 16′ are preferably shown as a magnetic circuit, and the actuator is shown as the magnet 56, various other means can be used, such as an electrical circuit, a fiber optic circuit, or the like in accordance with the present invention. Likewise, various means, such as limit switch 66 shown in FIG. 12 can also be incorporated for sensing the opening and closing of the circuit. For example, limit switch 66 includes arm 68 operatively connected to arm 50 to sense pivoting of the arm 50 as a response to movement of the latch 34 and linear movement of pull 38. A signal is generated indicating that the circuit is broken, as shown by gap 60. Alternatively, a signal is stopped that would otherwise indicate that the door latch assembly 12 is engaged within the doorjamb 14. Also, circuits 16, 16′ can include several different circuits which all can activate an alarm by a signal. For example, one circuit 16, 16′ can sense that the latch 34 is in the door jamb 14, one circuit 16, 16′ can sense that the door 20 is in a locked condition, and one circuit 16, 16′ can sense that the latch 34 is retracted. Each of the three circuits would be in connection with the signal to the alarm. Thus, the circuit 16, 16′ would provide for differentiation between the door 20 being opened, closed, and closed and locked.

In operation, when a door is open relative to a door frame, the circuit 16 is in the open condition. When the door is closed within the door frame, and closed completely, the latch 34 is engaged within the doorjamb 14. The circuit 16 is not in the closed condition until the door is locked by key, by pivot button 44 or the like. Once the door latch assembly 12 is actuated into the locked condition and the door latch 34 is completely within the doorjamb 14 and in the fully extended condition, then the circuit 16 is complete and the magnet 56 actuates the circuit. The reed switch 18 located in the path of the magnetic field detects the energized magnetic path resulting in the actuation of the signal, alarm and/or surveillance system providing indication, signal or alarm as to the locked or unlocked condition of the door. Thus, the present invention provides a method of sensing when a door latch assembly is in a locked condition or and in engagement with a door jamb by the general steps of closing the circuit 16 when the door latch assembly 12 is in the locked condition. The circuit 16 is actuated with an actuator, preferably in the form of the magnet 56 as shown in the drawings, disposed within the doorjamb 14 when the circuit is closed and the door latch assembly 12 engages the doorjamb 14. A signal is emitted from the door latch assembly through the reed switch 18 in response to the circuit 16 being closed and actuated indicating that the door latch assembly 12 is in the engaged and locked condition.

Finally, the present invention provides a door assembly incorporating the present invention as described above.

Thus the lock detection system of the present invention provides a locked condition signal only when the door 12 is closed, the latch bolt 34 is located in the doorjamb opening 14 and the lock actuated.

The detection system of the present invention can be utilized with other non-contact type detectors and energy generators. In this regard, while the door latch assembly 10 is shown to be actuated by doorknobs 26 and 28 in the figures, handle type actuators can be used. Also while a key actuated lock is shown and described, as previously noted, other types of lock actuation could be employed, such as lever, push button, and other lock actuators as are known to those of skill in the art.

Throughout this application, author and year and patents by number reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A lock sensor detection system for detecting when a door latch assembly is in a locked condition and in engagement with a doorjamb, said system comprising:
a circuit having an open and closed condition, said circuit being in said closed condition when the door latch assembly is in said locked condition; and the door lock assembly engages the doorjamb;
actuator means adapted to be disposed in the door jamb for actuating said circuit when said circuit is in said closed condition and the door latch assembly engages the doorjamb;
and signal means adapted to be disposed within and operatively connected to the door latch assembly for providing a signal in response to said circuit being in said closed and actuated conditions indicating that the door latch assembly is in an engaged locked condition.

2. A lock sensor detection system of claim 1, further including switch mean operatively connected to said circuit for detecting when said circuit is in said closed and actuated conditions and operatively connected to said signal means for actuating said signal means when said circuit is in said closed and actuated conditions.

3. A lock sensor detection system of claim 2, wherein said circuit includes a latch in conductive communication through the door latch assembly to an arm movable into and out of operative connection with said switch means, which is operatively connected through said door latch assembly to said latch, said circuit being in said closed condition when said arm is in operative connection with said switch means and in said open condition when said arm is out of operative connection with said switch means.

4. A lock sensor detection system of claim 3, wherein said arm is operatively connected to a locking mechanism of a door latch assembly, the locking mechanism moving said arm to close said circuit when in a locked condition and to open said circuit when in an unlocked condition.

5. A lock sensor detection system of claim 3, wherein said latch includes extended and retracted conditions, said circuit means being in said open condition when said latch is in said retracted condition to prevent said circuit from being in said closed condition if said latch is in said retracted condition.

6. A lock sensor detection system of claim 5, wherein said actuator means included a magnet adapted to be disposed in a doorjamb for actuating said circuit when said circuit is in said closed condition and said latch is in said extended condition.

7. A lock sensor detection system of claim 3, wherein said circuit includes at least two screw members operatively connected at a first end through a doorjamb circuit portion and at a second end through an arm movable into and out of operative connection with said circuit, said actuator means being operatively connected to said door jamb circuit portion and said arm being operatively connected to said switch means when said circuit is in said closed condition.

8. A method of sensing when a door latch assembly is in a locked condition and in engagement with a door jamb, said method including the steps of;
closing a circuit when a door latch assembly is in a locked condition;
actuating the circuit with an actuator disposed in a door jamb when the circuit is closed and the door latch assembly engages the doorjamb; and
emitting a signal from the door latch assembly in response to the circuit being closed and actuated indicating that the door latch assembly is in an engaged and locked condition.

9. A door latch assembly comprising:
a circuit having an open and closed condition, said circuit being in said closed condition when said door latch assembly is in said locked condition; actuator means adapted to be disposed in a door jamb for actuating said circuit when said circuit is in said closed condition and said door latch assembly engages the door jamb; and
signal means disposed within and operatively connected to said door latch assembly for providing a signal in response to said circuit being in said closed and actuated conditions indicating that the door latch assembly is in an engaged and locked condition.

10. A door assembly comprising:
a circuit having an open and closed condition, said circuit being in said closed condition when the door latch assembly is in said locked condition;
actuator means adapted to be disposed in the door jamb for actuating said circuit when said circuit is in said closed condition and said door latch assembly engages the doorjamb; and
signal means disposed within and operatively connected to said door latch assembly for providing a signal in response to said circuit being in said closed and actuated conditions indicating that the door latch assembly is in an engaged and locked condition.
